(19) United States
(12) Patent Application Publication
(10) Pub. No.: US 2004/0192864 A1
(43) Pub. Date: Sep. 30, 2004

(54) Utility conduit resin

(76) Inventor: Thomas W. Towles, Baton Rouge, LA (US)

Correspondence Address: ExxonMobil Chemical Company, Law Technology, P.O. Box 2149, Baytown, TX, 77522-2149, US

(21) Appl. No.: 10/784,460

(22) Filed: Feb. 23, 2004

(30) Foreign Application Priority Data
Mar. 31, 2003 (WO) PCT/US03/98969

(51) Int. Cl. C08F 4/06

(52) U.S. Cl. 526/113

(57) ABSTRACT

This invention is related to conduit resins comprising ethylene made using an activated chromium and titanium-based catalyst.

### CROSS-REFERENCE TO RELATED APPLICATIONS

The present application claims the benefit of International Application No. PCT/US03/09869, filed Mar. 31, 2003, said application incorporated herein by reference.

### FIELD OF THE INVENTION

This invention is related to utility conduit resin comprising polyethylene.

### BACKGROUND

Conduit resin comprising polyethylene resin is typically used in a continuous extrusion process comprising extruding the resin through a die to provide a hollow pipe or conduit which can carry utilities such as wire, cable, fiber optics, and the like. The electrical conduit market alone uses over 300 million pounds of HDPE annually. The term “conduit” in the art is used to distinguish this type of hollow tube from large diameter pipe, such as highway drainage pipe. These different uses have radically different requirements.

The emphasis in the conduit market is for a resin that exhibits high ESCR (Environmental Stress Crack Resistance) and that may be easily extruded through a relatively small diameter die. In the development of resin there is typically a trade off between characteristics such as resistance to slow crack growth and rupture (measured, for instance, by ESCR), stiffness (measured, for instance, by density) and processability or more specifically ease of extrusion (measured, for instance, by melt index or MI). Typically the higher the molecular weight of polyethylene, the higher the resistance to crack growth. However, increasing the molecular weight will decrease processability and make extrusion more difficult.

The manufacturers of the conduit typically have an investment in having their extrusion apparatus set to accept a resin having a certain processability range and the challenge for the resin manufacturer is to provide the target processing characteristics while at the same time optimizing end use characteristics as much as possible. The problem is then to supply the appropriate resin with consistent quality and acceptable price.

U.S. Pat. No. 6,403,181 B1 relates to a premium performance polyethylene produced using a metallocene transition metal catalyst, providing a high molecular weight component and a low molecular weight component.

A number of patents are directed to producing HDPE having good resistance to stress cracking, for instance U.S. Pat. No. 6,214,947, WO 00/14129, and EP 0905148. Typically such patents are directed to the catalyst systems employed in the production of the HDPE and more specifically to complicated preparation and/or treatment techniques such catalysts to optimize activity and catalyst life, among other characteristics.

However, what is needed is a process for producing a resin targeted for the conduit market, wherein the process uses a readily available catalyst, for instance a commercial catalyst, that may be easily and reproducibly activated and wherein the resultant activated catalyst has high activity and long life.

The present inventor has discovered a method of making a conduit resin having a high ESCR and good processability using a chromium and titanium-based supported catalyst which is commercially available and which may be readily activated for polymerization so as to provide for an excellent MI response, high activity, and long catalyst life.

Embodiments of the present invention may have the advantage over previously known methods of producing conduit HDPE by having improved MI (melt index) and an improved ESCR (Environmental Stress Crack Resistance).

### SUMMARY OF THE INVENTION

It is an object of this invention to provide a process to polymerize ethylene, or ethylene and at least one other olefin to produce a polymer particularly suitable for electrical conduit.

It is also an object of this invention to provide said polymer in an efficient manner using a catalyst activated for polymerization so as to provide for an excellent MI response, high activity, and long catalyst life.

It is still a further object of this invention to provide electrical conduit from the polyethylene produced according to the present invention.

It is yet still a further object to provide an activated catalyst to provide for the conduit of the present invention.

These and other objects, features and advantages of the present invention will become apparent as reference is made to the following detailed description, additional embodiments, specific examples, and appended claims.

### DETAILED DESCRIPTION

The conduit resin according to the invention can be polymerized using any known process in the art for producing polyethylene, such as gas phase, solution or slurry polymerization conditions. A stirred reactor can be utilized for a batch or continuous process, or the reaction can be carried out continuously in a loop reactor.

In an embodiment, the polymerization occurs in a slurry loop reactor under slurry polymerization conditions. Loop reactors are known in the art, see, for example, U.S. Pat. Nos. 3,248,179; 4,424,341; 4,501,855; 4,613,484; 4,589,957; 4,737,280; 5,597,892; and 5,575,979.

In a more preferred embodiment, the polymerization technique is slurry loop reactor, particularly those described in U.S. Pat. Nos. 6,319,997; 6,204,344; 6,281,300; and 6,380,325.

Typically slurry loop polymerization is conducted at temperature conditions in the range of from about 88-110° C. (190-230° F.). However, using a catalyst according to the present invention, conduit resin fouling conditions occur at temperatures above about 102° C. (215° F.). It is preferred that polymerization occur between 99-102° C. (210-215° F.).

Typical slurry loop polymerization is conducted at pressures in the range of about 400 psia to about 800 psia. Again, using a catalyst according to the present invention within the preferred temperature range, pressures of about 500-600 psig (515±615 psia) are preferred.

Numerous diluents are known to be useful in the slurry loop process. The preferred diluent in a process according to the present invention is isobutane.

The catalyst treated by the process according to the present invention comprises chromium and titanium on a support. In order to achieve the maximum advantages provided by the present invention, the supported catalyst further comprises hydrocarbon residues, as described more fully below. In one embodiment the catalyst is supported on silica. In another embodiment a silica/alumina support is used.

In an embodiment described herein, the chromium and titanium-based supported catalyst to be treated by the method described herein has hydrocarbon residues deposited thereon. “Hydrocarbon residues” as used herein means any species or moiety containing hydrogen and carbon, which is present on the catalyst and/or support. Without limitation, such hydrocarbon residues may be present on the catalyst and/or support as a result of having been deposited during the manufacture of the catalyst or support, such as organic solvent residues or by the deposition of one or more of chromium, titanium, zirconium, aluminum, and boron on the support from an organic solution (e.g., chromium acetate), such as described in the previously mentioned U.S. Pat. No. 5,895,770. Hydrocarbon residues may also be present in supported catalysts comprising chromium and/or titanium made by gel processes such as in the cogel and tergel catalysts described in the previously mentioned EP patents. The present invention is applicable to any chromium and titanium-based supported catalyst having hydrocarbon residues thereon or therein, however made.

As used herein, the terms “chromium and titanium-based supported catalyst” is intended to distinguish the catalyst according to the present invention from a “chromium-based catalyst” which does not contain titanium.

In a preferred embodiment of the invention, the process concerns the activation of catalyst, where the catalyst is a chromium and titanium-based supported catalyst supported on silica or silica/alumina, wherein the chromium and titanium and optional species, if present, have been deposited from solution prior to the treatment according to the present invention, and hydrocarbon residues are present at least in part as a result of this deposition process (e.g., it may be from the solvent or metal counter ion). Hydrocarbon residues may also be present as a result of the manufacture or processing of the support.

The catalyst used in the process according to the present invention is a chromium and titanium-based supported catalyst activated in a reactor at about 370-540° C. (700-1000° F.), preferably 370-450° C. (700-850° F.), more preferably 370-425° C. (700-800° F.), still more preferably 370 to 400° C. (700-750° F.), under an inert atmosphere, followed by the introduction of an oxidant, preferably in the form of air, and controlling the reactor temperature so that the temperature of the catalyst reactor does not exceed 510° C. (950° F.), preferably no higher than about 480° C. (900° F.), and yet still more preferably no higher than about 450° C. (850° F.), most preferably no higher than about 425° C. (800° F.).

In another embodiment the reactor temperature is controlled by the rate of addition of oxidant and by the temperature of the gas entering the reactor. Thus, the present invention also includes a process for polymerizing ethylene including treating a chromium and titanium-containing supported catalyst at about 370-400° C. (700-750° F.) under an inert atmosphere which may be at least partially preheated to a temperature higher or lower than the reactor temperature, followed by the controlled introduction of oxidant, preferably in the form of air, which has been preheated to a temperature no greater than about 400° C. (750° F.), most preferably by air which has been preheated to about 200° C. (400° F.) or less, while controlling the temperature spike so that the temperature of the catalyst reactor does not exceed 510° C. (950° F.), preferably no higher than about 480° C. (900° F.), and yet still more preferably no higher than about 450° C. (850° F.), most preferably no higher than about 425° C. (800° F.).

The chromium and titanium-based supported catalyst according to the present invention is then placed in an activator or reactor to be treated by the process according to the present invention. The terms “activator” and “reactor” are used interchangeably herein for convenience. The invention may be practiced using any known method for bringing gases and solids into contact with each other, such as in a static bed or a fluidizing bed. Advantageously the activator will be a fluidized bed reactor.

The reactor may be heated by, for instance, internal reactor heating rods, by an external source of heat applied to the reactor walls, such as electrical heat or by heat of combustion, by provision for heating the gas entering the reactor via one or more gas inlet valves, or by a combination of such heating sources, all of which can be measured and controlled by means per se well known.

It should be noted that, as used herein, “reactor temperature” is typically measured at or very close to the catalyst bed and thus, as would be understood by one of skill in the art, “reactor temperature” is taken as surrogate for the temperature of the catalyst.

In another embodiment of the invention, in addition to the temperature hold period described above, additional hold periods at temperatures lower than 370° C. (700° F.) are contemplated. Thus in one embodiment the reactor temperature is ramped up from room temperature to about 180° C.-230° C. (355° F.-445° F.) at about 220° C./hr (400F/hr) and held at this temperature under a nitrogen atmosphere for a period of one minute to up to about 6 hours, or even more, followed by a temperature ramp up to a preselected temperature between about 370-540° C. (700-1000° F.), preferably 370-450° C. (700-850° F.), more preferably 370-425° C. (700-800° F.), still more preferably 370 to 400° C. (700-750° F.), at a rate of about 200° C./hr (350° F./hr), while still under an inert atmosphere. This temperature and inert atmosphere is then held constant for a period of from one minute up to about 6 hours. Even greater hold periods are possible, however the benefits, if any, are generally offset by the greater cost.

The nitrogen (or inert gas) treatment may occur to an even higher temperature, however (again without wishing to be bound by theory) it is believed that above about 540° C. (1000° F.) the supported chromium and titanium catalyst may be converted partially or wholly into a form (“green batch”) which is less amenable to a subsequent treatment with oxygen. A green batch may also be observed under conditions where the oxygen is present at a concentration of less than about 20% by volume, i.e., less oxygen than is normally present in air. Thus temperatures of above about 540° C. (1000° F.) should be avoided during the treatment under pure nitrogen or other inert gaseous treatment and during conditions where pure nitrogen is mixed with air.

Activation may then be completed by contacting the catalyst in the reactor with an oxidizing atmosphere, preferably and atmosphere consisting essentially of air. The final temperature of the reactor under an oxidizing atmosphere, preferably an atmosphere consisting essentially of air, is 605-695° C. (1120-1280° F.), for a period of from 1 minute to 10 hours, preferably 3.5 to 8 hours, more preferably 4 to 7 hours and yet still more preferably 6 hours. While a treatment at this temperature for more than 6 hours is possible, the advantages, if any, are typically offset by the cost.

The final activation temperature is a key to the conduit resin according to the present invention. A lower final hold temperature yields a polymer having a better ESCR but is too difficult to produce on the reactor, while a higher final hold temperature yields a more easily produced HDPE but without adequate ESCR.

It should be noted that, as used herein, “reactor temperature” is typically measured at or very close to the catalyst bed and thus, as would be understood by one of skill in the art, “reactor temperature” is taken as surrogate for the temperature of the catalyst.

The thus-activated supported chromium and titanium-based catalyst is then preferably cooled to about 150-315° C. (300-600° F.), purged with nitrogen while cooling to room temperature and then used as desired.

The amount of chromium on said support is in the range of about 0.5 to about 5 weight percent, preferably about 1 weight percent, and the amount of titanium is about 1-6 weight percent, preferably about 3.5 weight percent. The weight percents of the metals are based on the weight of the support.

In an embodiment the chromium and titanium-based catalyst does not contain added metals, such as aluminum, boron, and zirconium (other than what is provided by the support, e.g., silica or silica/alumina). In another embodiment, additional metals, such as aluminum, are permissible. In an embodiment, additional metals are permissible provided they do not materially affect the basic characteristics of the catalyst or the activation procedure according to the present invention.

Catalysts useful for the present invention are commercially available from PQ Catalyst Corporation, Philadelphia, Pa.

The ethylene used should be polymerization grade ethylene. The other olefins that can be used are alpha-olefins having from 3 to 10 carbon atoms. Numerous acceptable alpha-olefins will be apparent to one of ordinary skill in the art in possession of the present disclosure. The preferred olefins to be copolymerized are 1-butene, 1-hexene, and 1-octene.

The conduit resin according to the present invention preferably has a density of about 0.942-0.952 g/cm³ (ASTM D-4883) and a preferred range of MI₂ of 0.15-0.45 g/10 min (ASTM D-1238). These characteristics may be readily achieved by one of ordinary skill in the art in possession of the present disclosure. Reference will be made to the following specific example, which is not intended to be limiting.

### EXAMPLE 1

A silica-supported chromium and titanium-based catalyst activation was performed on a commercially available catalyst, PQ C-25307™, available from PQ Catalyst Corporation, Philadelphia, Pa.

The catalyst is placed in a fluidizing bed reactor of the type well-known in the art. The reactor comprises heating rods to heat the catalyst bed and gas inlets with preheaters. The catalyst is fluidized with dry N₂ and the temperature of the reactor/catalyst bed is ramped up at about 222° C./hr (400° F./hr) to 205° C. (400° F.). It is held at this temperature under a nitrogen flow of about 126 CFM (cubic feet per minute) for 4 hours and then ramped at about 195° C./hr (350° F./hr) to a hold at about 400° C. (750° F.) under a nitrogen flow of about 144 CFM. The catalyst is held in the reactor under these conditions for about 3.5 hours. The gas inlet preheaters are set to 450° C. (850° F.) during the period that the reactor temperature is held at 400° C. (750° F.) under nitrogen, and shortly before the introduction of the 20 CFM of air, the gas inlet preheaters are lowered to about 200° C. (400° F.).

Then a controlled amount of oxidant is introduced, in the form of dry air at a rate of 20 CFM, with a decrease in the nitrogen flow to approximately 122 CFM, so that the amount of oxygen in the reactor is at a concentration of about 2.8% by volume, while maintaining the reactor at about 400° C. (750° F.). A temperature spike to about 425° C. (800° F.) is observed in the reactor shortly after the partial oxygen environment is introduced, but the reactor temperature approaches 400° C. (750° F.) within about 90 minutes. The gas inlet preheaters remain set at about 200° C. (400° F.) during this period.

The atmosphere is then switched to 100% dry air and the temperature is ramped using both the reactor probe heaters and the gas inlet preheaters, at about 83° C. (150° F./hr) to a 6 hour hold at 650° C. (1200° F.) and held for 6 hours, to complete activation.

The catalyst is then cooled to about 150-205° C. (300-400° F.) under an atmosphere of air and then fluidized with nitrogen and allowed to come to room temperature.

The thus-activated catalyst is used in a slurry loop polymerization process to produce HDPE resin under the conditions previously described, using in this case 1-hexene as the comonomer.

The resin has a Melt Index (190/2.16) of 0.30 g/10 min (ASTM D-1238), Density of 0.946 g/cm³ (ASTM D-4883), and ESCR>96 hours (ASTM D-1693, Condition B, F20, 10% Igepal). This resin is particularly suitable for telecommunications conduit pipe (although the aforementioned values should not be interpreted as specifications therefor).

Trade names used herein are indicated by a ™ symbol, indicating that the names may be protected by certain trademark rights. Some such names may also be registered trademarks in various jurisdictions.

All patents and patent applications, test procedures (such as ASTM methods), and other documents cited herein are fully incorporated by reference to the extent such disclosure is not inconsistent with this invention and for all jurisdictions in which such incorporation is permitted.

All temperatures were measured using ° F. scale and thus some additional tolerance should be allowed for rounding during conversion of these temperatures to ° C. scale, in addition to the ordinary tolerance provided for the term “about”.

When numerical lower limits and numerical upper limits are listed herein, ranges from any lower limit to any upper limit are contemplated.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains.

Thus many variations of the following embodiments will suggest themselves to those skilled in this art in light of the above detailed description: a process for producing a resin suitable for use as utility conduit comprising polymerizing ethylene or copolymerizing ethylene and an alpha-olefin comonomer comprising 3 to 10 carbon atoms, in the presence of a chromium and titanium-based catalyst activated by: (a) contacting said catalyst in a reactor at a temperature of between about 370-540° C. (700-1000° F.), preferably 370-450° C. (700-850° F.), more preferably 370-425° C. (700-800° F.), still more preferably 370 to 400° C. (700-750° F.) with an atmosphere consisting essentially of an inert gas; and then (b) introducing an oxidant, preferably air, into said reactor so that the temperature of said reactor does not exceed about 510° C. (950° F.), preferably does not exceed about 480° C. (900° F.), and yet still more preferably does not exceed 450° C. (850° F.), most preferably does not exceed about 425° C. (800° F.); and then (c) completing the activation of said catalyst in a reactor at a temperature of about 605-695° C. (1120-1280° F.), preferably for a period of from 1 minute to 10 hours, more preferably 3.5 to 8 hours, still more preferably 4 to 7 hours and yet still more preferably 6 hours, under an oxidizing atmosphere, preferably an atmosphere consisting essentially of air; also a resin suitable for use as utility conduit made by the process and process variations described above, which may also be characterized as a resin comprising the residue of a chromium and titanium-based catalyst activated by: (a) contacting said catalyst in a reactor at a temperature of between about 370-540° C. (700-1000° F.), preferably 370-450° C. (700-850° F.), more preferably 370-425° C. (700-800° F.), still more preferably 370 to 400° C. (700-750° F) with an atmosphere consisting essentially of an inert gas; and then (b) introducing an oxidant, preferably air, into said reactor so that the temperature of said reactor does not exceed about 510° C. (950° F.), preferably does not exceed about 480° C. (900° F.), and yet still more preferably does not exceed 450° C. (850° F.), most preferably does not exceed about 425° C. (800° F.); and then (c) completing the activation of said catalyst in a reactor at a temperature of about 605-695° C. (1120-1280° F.), for a period of from 1 minute to 10 hours, preferably 3.5 to 8 hours, more preferably 4 to 7 hours and yet still more preferably 6 hours, under an oxidizing atmosphere, preferably an atmosphere consisting essentially of air; and also an article made by extruding the composition previously described in any of the embodiments, the article being characterized by having a hollow core, and also to the use of the extruded composition to carry or house material, particularly electrical wire, cable, optical fibers, and the like (which may be characterized as utilities or material carrying electromagnetic energy), but also fluids (liquids and gases).

I claim:

1. A process for producing a resin suitable for use as utility conduit comprising polymerizing ethylene or copolymerizing ethylene and an alpha-olefin comonomer comprising 3 to 10 carbon atoms, in the presence of a chromium and titanium-based catalyst activated by:
(a) contacting said catalyst in a reactor at a temperature of between about 370-540° C. (700-1000° F.) with an atmosphere consisting essentially of an inert gas; and then
(b) introducing an oxidant into said reactor so that the temperature of said reactor does not exceed about 510° C. (950° F.); and then
(c) completing the activation of said catalyst in a reactor at a temperature of about 605-695° C. (1120-1280° F.) under an oxidizing atmosphere.

2. The process according to claim 1, wherein the temperature of said reactor in (a) does not exceed about 450° C. (850° F.).

3. The process according to claim 1, wherein the temperature of said reactor in (b) does not exceed about 450° C. (850° F.).

4. The process according to claim 1, wherein the temperature of said reactor in (a) does not exceed about 400° C. (750° F.) and the temperature of said reactor in (b) does not exceed about 425° C. (800° F.).

5. The process according to claim 1, wherein (c) further comprises completing the activation at said temperature and under said oxidizing atmosphere for a period of from 1 minute to 10 hours.

6. The process according to claim 5, wherein said period in (c) is from 4 to 7 hours.

7. The process according to claim 1, wherein said oxidizing atmosphere in (c) is an atmosphere consisting essentially of air.

8. The process according to claim 5, wherein said oxidizing atmosphere in (c) is an atmosphere consisting essentially of air.

9. The process according to claim 6, wherein said oxidizing atmosphere in (c) is an atmosphere consisting essentially of air.

10. The process according to claim 1, wherein said resin has a density of about 0.942-0.952 g/cm³ (ASTM D-4883), a range of MI₂ of 0.15-0.45 g/10 min (ASTM D-1238), and ESCR>96 hours (ASTM D-1693, Condition B, F20, 10% Igepal).

11. A resin suitable for use as utility conduit, further characterized as comprising the residue of a chromium and titanium-based catalyst activated by:
(a) contacting said catalyst in a reactor at a temperature of between about 370-540° C. (700-1000° F.) with an atmosphere consisting essentially of an inert gas; and then
(b) introducing an oxidant into said reactor so that the temperature of said reactor does not exceed about 510° C. (950° F.); and then
(c) completing the activation of said catalyst in a reactor at a temperature of about 605-695° C. (1120-1280° F.) under an oxidizing atmosphere.

12. The resin according to claim 11, said resin having a density of about 0.942-0.952 g/cm³ (ASTM D-4883), a range of MI₂ of 0.15-0.45 g/10 min (ASTM D-1238), and ESCR>96 hours (ASTM D-1693, Condition B, F20, 10% Igepal).

13. An article made by extruding the composition according to claim 11, said article having a hollow core.

14. The article according to claim 13, wherein said article comprises a resin having a density of about 0.942-0.952 g/cm³ (ASTM D-4883), a range of MI₂ of 0.15-0.45 g/10 min (ASTM D-1238), and ESCR>96 hours (ASTM D-1693, Condition B, F20, 10% Igepal).

15. The article according to claim 13 further comprising a utility carrying electromagnetic energy within said hollow core.
